(19) United States
(12) Patent Application Publication
(10) Pub. No.: US 2016/0014477 A1
(43) Pub. Date: Jan. 14, 2016

(54) Systems and Methods for Synchronized Playback of Social Networking Content

(71) Applicant: Benjamin J. Siders, St. Peters, MO (US)

(72) Inventor: Benjamin J. Siders, St. Peters, MO (US)

(21) Appl. No.: 14/620,070

(22) Filed: Feb. 11, 2015

Related U.S. Application Data
(60) Provisional application No. 61/938,359, filed on Feb. 11, 2014.

(51) Int. Cl. H04N 21/81; H04L 29/08; H04N 21/2187; H04N 21/472; H04N 21/4788; H04N 21/6587; H04N 21/643; H04L 29/06; H04N 21/4147

(52) U.S. Cl. CPC H04N 21/8133; H04L 65/1089; H04L 65/4015; H04L 67/306; H04N 21/2187; H04N 21/4147; H04N 21/4788; H04N 21/6587; H04N 21/64322; H04N 21/47217

(57) ABSTRACT

Systems and methods for preventing social networking content associate with a particular live event from being delivered to a user during the live event, and for facilitating delivery of such content in synchronization with a time-shifted viewing of the live event.

### CROSS REFERENCE TO RELATED APPLICATION(S)

This application claims benefit of U.S. Provisional Patent Application No. 61/938,359 filed Feb. 11, 2014, the entire disclosure of which is incorporated herein by reference.

### BACKGROUND

1. Field of the Invention

This disclosure is related to the field of social networking, specifically to synchronizing the delivery of time-sensitive communications and content with the viewing of the subject matter to which it pertains.

2. Description of the Related Art

The explosion in popularity of social media and social networking has fundamentally altered existing mass media technologies. In particular, activities such as watching a television program have been transformed into an interactive communal activity, as viewers can talk to each other during a broadcast about what is taking place on the screen.

Certain technologies, such as Twitter, are particularly conducive to this type of interaction, in part because the short message length requires viewers to convey their thoughts briefly and quickly, which in turn allows other viewers to quickly read them. Social networking is becoming integrated into the broadcast experience, as cast, crew, media, and critics interact with viewers during the broadcast. This is encouraged in many broadcasts through the use of hashtags provided in the broadcast to enable viewers to find each other and relevant content pertaining to the show.

Certain live programming, notably sporting events, concerts, and other real-time broadcasts, are particularly conducive to this type of discussion because none of the viewers know the outcome. Similarly, broadcasts of new episodes of popular programs can generate an enormous amount of discussion and traffic.

However, problems arise for users who are not able to watch the live broadcast, such as because they are at work or another prior engagement that inhibits them from consuming the live broadcast. Many users now watch programming on a tape-delay by recording the live broadcast and replaying the content later, such as by using a digital video recorder (“DVR”) device. Those users are sometimes forced into a social media black hole where they do not answer phone calls, do not read email or texts, avoid Twitter and Facebook, and shun technology to avoid having the outcome or conclusion of the broadcast spoiled.

This is because a major portion of the drama in live broadcasting comes from the fact that the outcome is not known. Because the drama and enjoyment of many types of broadcasts is inherent in the uncertainty of the outcome, the user cannot fully enjoy the experience of consuming the programming unless the user does not know the outcome. For example, a viewer who missed a favorite sports team's game may record the game on a DVR and play it back later. That user likely follows a number of social media and networking contacts who also like that sports team and may comment on the game. To avoid having the outcome spoiled, the user must avoid Twitter to reduce the odds that the user sees a final score or stray comment which implies the outcome, or an event that took place during the game or broadcast.

Thus, the user watching the programming on delay faces a choice: lose out on the fun and excitement of watching the programming without knowing the outcome in advance, or spend the intervening time between the broadcast and the user's playback of the recording in a social media bubble, and miss out on consuming social media content as the event unfolds. If the user goes into a social media bubble, the user may miss important messages not pertaining to the missed broadcast, such as messages from family, friends, or colleagues who did not watch the event or can be trusted not to spoil the outcome.

### SUMMARY

Because of these and other problems in the art, described herein, among other things, is a system for providing legal analytics to an attorney comprising: a computer server communicating over a data network, the computer server comprising: a database having one or more datasets comprising legal data and one or more datasets comprising actionable analytics, each one of the one or more analytics being derived at least in part from legal data in at least one of the one or more legal data datasets; a microprocessor; a non-transitory machine-readable storage comprising machine-readable instructions which, when executed by the microprocessor, cause the computer server to provide over the data network, in response to a user request comprising search criteria data, a response datagram comprising response data indicative at least one of the one or more analytics, the at least one of the one or more analytics being selected based at least in part on the search criteria data.

Described herein, among other things, is a method for synchronized playback of social networking content comprising: providing a social networking platform; providing a digital video recorder communicably attached to a network; providing a social networking playback device communicably attached to the network; indicating to the digital video recorder a live event desired to be recorded; sending over the network an indication of the desired live event and an indication of a user of the social networking playback device; a server receiving the indication of the desired live event and the indication of the user; the desired live event commencing at an event start time; during the desired live event, the server monitoring the social networking platform for one or more social networking messages for the received indication of the user related to the received indication of the desired live event and, for each social networking message in the one or more social networking messages, calculating and storing a time index indicating a time during the desired live event when the each message was published on the social networking platform relative to the event start time; during the desired live event, the digital video recorder recording the desired live event; using the digital video recorder, playing back the recording of the desired live event at a playback starting time; for each social networking message in the one or more social networking messages, displaying the each social networking message on the social networking playback device at a point in time corresponding to the calculated time index for the each message relative to the playback starting time.

In an embodiment, the method further comprises: during the desired live event, preventing at least one of the one or more social networking messages from being displayed on the social networking playback device.

In a further embodiment, the method further comprises: displaying on the social networking playback device, in place of the prevented at least one message, an indication that the prevented message was prevented from being displayed on the social networking playback device.

In a further embodiment, the method further comprises: wherein the displayed indication that the prevented message was prevented from being displayed on the social networking playback device further comprises a user-operable interface component which, if operated by the user, causes the prevented message to be displayed on the social networking playback device.

In an embodiment, the social networking playback device is a mobile phone, tablet computer, or wearable computer.

In an embodiment, the network is the Internet.

In an embodiment, the live event is a sport.

In an embodiment, the method further comprises: in response to a user command pausing playback on the digital video recorder, the digital video recorder causing the user device to pause playback of the one or more social networking messages.

### BRIEF DESCRIPTION OF THE DRAWINGS

FIGS. 1A and 1B depicts a schematic time lines showing an embodiment of systems and methods for synchronizing delivery of social networking messages pertaining to a broadcast event with playback of the broadcast of such event.

FIG. 2 depicts schematic time lines showing an embodiment of systems and methods for synchronizing delivery of social networking messages pertaining to a broadcast event with playback of the broadcast of such event, wherein the systems and methods include content-skipping features.

FIG. 3 depicts schematic time lines showing an embodiment of systems and methods for synchronizing delivery of social networking messages pertaining to a broadcast event with playback of the broadcast of such event, wherein the systems and methods include arbitrary playback-control features.

FIG. 4 depicts a schematic diagram of one embodiment of systems and methods for synchronizing delivery of social networking messages pertaining to a broadcast event with playback of the broadcast of such event.

FIG. 5 depicts a schematic diagram of one alternative embodiment of systems and methods for synchronizing delivery of social networking messages pertaining to a broadcast event with playback of the broadcast of such event.

FIG. 6 depicts a schematic diagram of an embodiment of systems and methods synchronizing delivery of social networking messages pertaining to a broadcast event with playback of the broadcast of such event.

FIG. 7 depicts a schematic diagram of another alternative embodiment of systems and methods for synchronizing delivery of social networking messages wherein a set-top box (e.g., DVR) communicates with the playback device to coordinate playback commands and controls.

### DESCRIPTION OF THE PREFERRED EMBODIMENT(S)

The following detailed description and disclosure illustrates by way of example and not by way of limitation. This description will clearly enable one skilled in the art to make and use the disclosed systems and apparatus, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Throughout this disclosure, the term “original broadcast” generally means the initial or original public distribution of audio content depicting an event or programming via mass media. Although modern broadcasts are generally audiovisual in nature, a broadcast may be audio or visual only. Similarly, other forms of conveying content via sensory input should be understood as included in this definition in certain applications, such as tactile. This term should be understood generally as referring to the original or initial public distribution as scheduled or intended by the producer, publisher, or distributor, such that members of the viewing public engage in generally simultaneous social media discussion of the event in real-time with the broadcast. Thus, the term “public” does not necessarily mean the entire public must have access to the event, but rather a sufficient number of viewers to generate social media traffic about the event. By way of example and not limitation, pay-per-view events can meet the definition of “original broadcast,” such as mixed martial arts competitions, boxing matches, and professional wrestling events whose original broadcasts are sometimes offered on a pay-per-view basis. This term should also be understood to include recorded or stored versions of original broadcasts whose or entertainment content is unmodified or substantially intact, even if such recorded or stored versions have been edited or modified. This term also does not necessarily mean that the content being broadcast has never been broadcast before, but rather should be understood as a reference to a particular broadcast of an event or programming. For example, a re-broadcast of Super Bowl XXXIV may be an “original broadcast” as used herein, particularly where the re-broadcast includes commentary or additional content produced with the benefit of hindsight as to the outcome of the game. Also by way of example and not limitation, a re-broadcast of television coverage of a famous historical event may be an “original broadcast” as used herein. The term “broadcast” should also not be understood as limited to television or radio broadcasts via conventional broadcast technology (e.g., broadcast towers), but rather as any form of broad distribution of content to the public or a sufficient portion thereof, including but not necessarily limited to through cable, satellite, Internet, wireless, digital, and other distribution channels.

Throughout this disclosure, the term “live” means an original broadcast at the time of its original broadcast, and should be understood as distinguished from viewing a replay of a broadcast. This term does not necessarily mean that the content of the original broadcast is itself “live” programming, but rather refers to the time at which a particular user consumes the content.

The terms “replay” should be understand as an individual user replaying a broadcast privately at a time other than the time of the original broadcast generally for the user's own private consumption. This should be understood as distinct from a re-broadcast of an original broadcast, which is itself another original broadcast.

The term “DVR” refers generally to one or more components of computer hardware and/or software implementing the recordation, storage, and playback of audiovisual or other multimedia content. Although the term generally refers to special-purpose hardware and software engineered for this purpose, this term refers to any technology implementing the described functionality. By way of example and not limitation, this term should be understood to encompass the use of streaming video and other distribution models.

Throughout this disclosure, the terms “event” or “show” or “program” are generally synonymous and refer to the content or subject matter of an original broadcast. Events may include sporting events, television shows, movies, news broadcasts, concerts, live broadcasts, recorded broadcasts, radio broadcasts, and the like.

Throughout this disclosure, the terms “social media” and “social networking” should be understood as synonymous and to generally mean communication service platforms implemented in computer hardware and/or software wherein users establish connections with one another for the exchange of information and communications, often pertaining to shared interests or activities. Examples include, but are not limited to: e-mail; text messaging; instant messaging; video chat; FaceTime™; telephone calls; telephony calls; VOIP calls; Facebook®; Twitter®; InstaGram®; Google+®; FourSquare®; Pinterest®; LinkedIn®; Flickr®; Tumblr®; Meetup; MySpace; and other web sites offering similar features and/or social networking functionality, such as PushUp Social. One of ordinary skill in the art will understand that as the feature set and use of social networking changes, the range of service platforms which meet this definition may also change.

The terms “post,” “publish,” and “produce” with respect to social media content should be understood as referring to the process of writing content for distribution on a social networking platform and/or making such content available to one's social networking contacts or the general public on a social networking platform.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, and mainframe computers.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer,” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable binary files, object code, compiled libraries, implementations, algorithms, or any instruction or set of instructions capable of being executed by a computer processor, or capable of being converted into a form capable of being executed by a computer processor, including without limitation virtual processors, or by the use of run-time environments or virtual machines. Those of ordinary skill in the art recognize that software can be wired directly onto hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers.

Throughout this disclosure, the term “real time” refers to software operating within operational deadlines for a given event to commence or complete, or for a given module, software, or system to respond, and generally invokes that the response or performance time is, in ordinary user perception and considered the technological context, effectively generally contemporaneous with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second, particularly where network operations are involved.

The definitions provided herein should not be understood as limiting, but rather as further clarification and explanation of what one of ordinary skill in the relevant art would understand the defined terms to mean respect to the description provided herein.

Although the present invention is described with particular reference to the accompanying drawings, it is to be understood at the outset that it is contemplated that the present invention may vary in specific detail from that illustrated and described herein while still achieving the desirable characteristics and features of the present invention. Accordingly, the description that follows is intended to be understood as a broad enabling disclosure directed to persons skilled in the applicable arts, and is not to be understood as being restrictive.

Described herein, among other things, are systems and methods for playback of social networking content pertaining to an event synchronized to a replay of the recorded broadcast. Generally speaking, the systems comprise one or more computer systems having one or more non-volatile, non-transitory memories containing computer programming instructions which, when executed by one or more microprocessors, cause an original broadcast to be recorded, cause a social networking message or content pertaining to the event and sent during the original broadcast to be recorded or stored, cause such message or content to not be delivered to a recipient of such message or content who is not watching the original broadcast and would otherwise receive the message or content, and cause such message or content to be delivered to such recipient at the point in time during such recipient's replay of the stored broadcast corresponding to the point in time during the original broadcast when such message or content was sent or would otherwise have been delivered to such recipient.

Generally speaking, the methods comprise storing or recording an original broadcast event, storing or recording a social networking message or content pertaining to the event and sent during the original broadcast of such event, not delivering such message or content to a recipient of such message or content who is not watching the original broadcast and would otherwise receive the message or content, deliver such message or content to such recipient at the point in time during such recipient's replay of the stored broadcast corresponding to the point in time during the original broadcast when such message or content was sent or would otherwise have been delivered to such recipient.

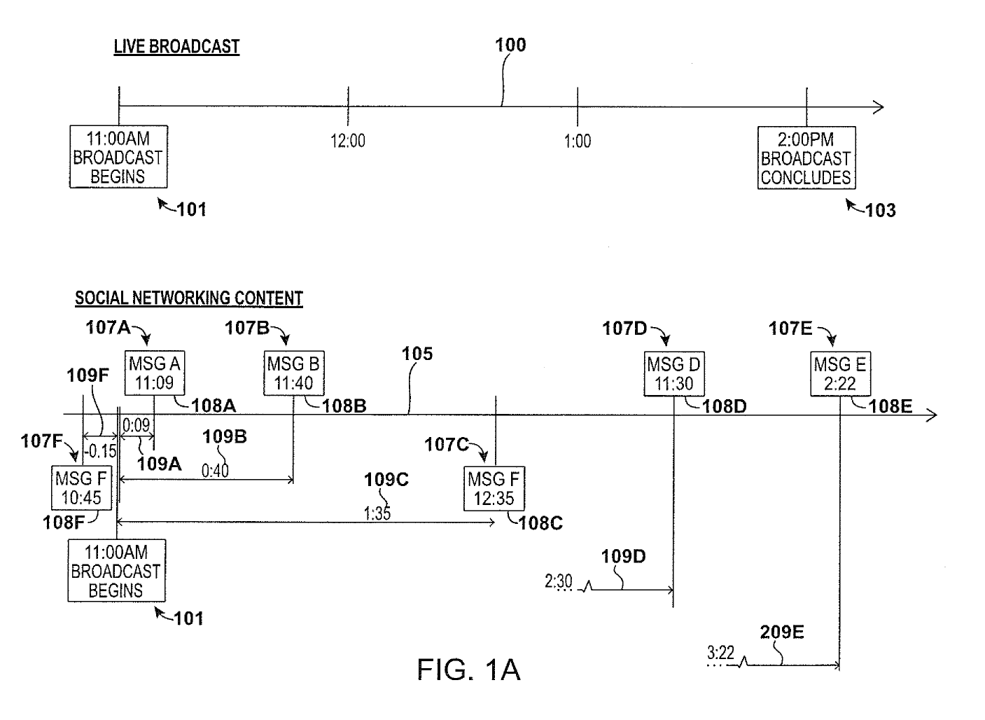

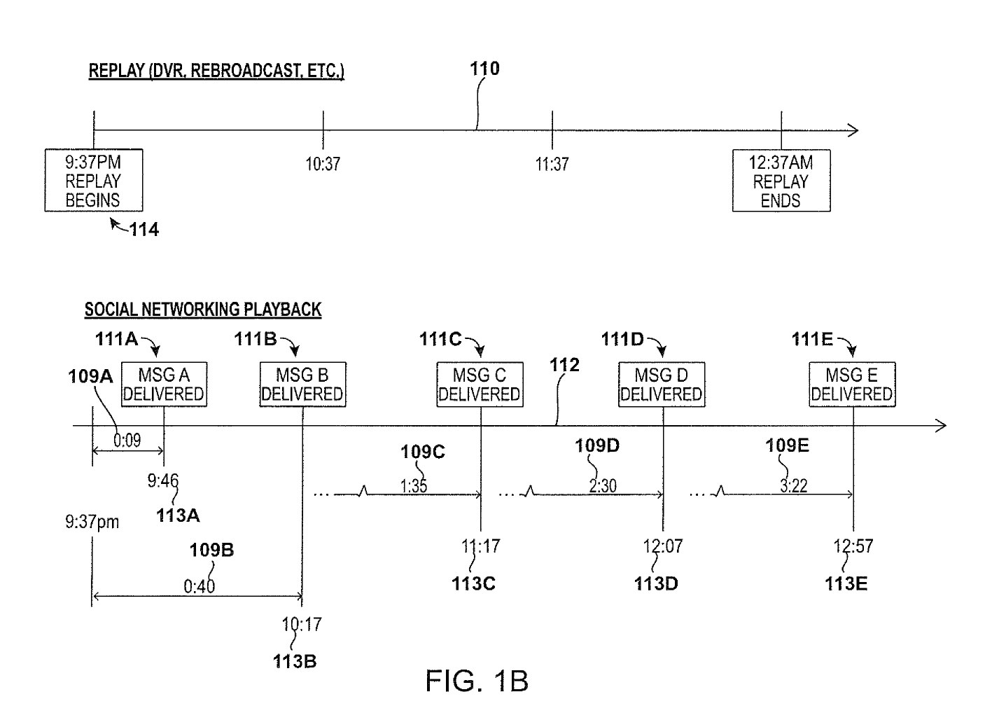

FIG. 1 depicts time lines in a basic embodiment of systems and methods for synchronizing playback of social media pertaining to an original broadcast with the playback of the original broadcast. The depicted embodiment uses time indexing. In the depicted embodiment, an indication of the amount of time which has elapsed from the beginning of the original broadcast until a social networking message pertaining to the broadcast is published is noted. This amount of time is known as the time offset, and is relative to the commencement of the original broadcast. When the original broadcast is played back by a user, the time offset for the social networking content is used to calculate a delivery time into the replayed broadcast by adding the time offset to the start time of the replayed broadcast. Tnd the message is delivered at or near the delivery time, causing the effect that the user watching the replayed broadcast receives the message at about the same time during the replayed broadcast that the user would have received the message had the user been watching the live broadcasting.

Original broadcast timeline (100) represents the timeline of an original broadcast of an event having an original broadcast start time (101) and an original broadcast end time (103). In the depicted embodiment, start time (101) is 11:00 am and end time (103) is 2:00 pm. At various points during original broadcast (100), social networking messages and/or content (107) pertaining to the event or the broadcast (100) are posted. Timeline (105) represents the timeline of such content (107). Social media messages may be published before (107F), during (107A, 107B, 107C, 107D), or after (107E) the broadcast (100). Each message (107) has an associated date/time (108) when the message (107) was published. The date/time (108) for a message (107) may be determined through any technique now known or in the future developed in the art, including but not necessarily limited to by: examining metadata; querying the social networking platform; screen scraping; observing the time of day when the message is initially posted or observed.

A user interested in the subject event of broadcast (100) but who cannot consume the original broadcast live may record or cause to be recorded a copy of broadcast (100). The user may replay (110) the recorded copy, depicted in timeline (110) at a time other than start time (101). Although users often replay (110) broadcasts after the original broadcast (100) concludes, users may also replay (110) the broadcast during a time period overlapping a portion of the original broadcast (100). This may be done, for example, to cache a recorded portion of the live original broadcast so that commercials may be skipped.

It is generally contemplated herein that the broadcast is recorded and replayed by the same device, generally a device engineered for that purpose, such as a digital video recording system (“DVR”). However, it is also expressly contemplated that a plurality of devices or systems may be used, and not all such systems need necessarily be in control of a user. For example, a user in an embodiment may stream a replay of a sporting event over a web site, in which case the device playing back the event is a computer in the possession of the user, whereas the device which recorded the event is not in the user's possession or control, and may not even be known by the user.

In the depicted embodiment of FIG. 1, content (107) would ordinarily be received by or made available in real-time (108) with the publication of content (107), but the content (107) is inhibited from delivery to a user. This is important because content (107) pertains to the subject of original broadcast (100) and if the user views content (107) before the appropriate time offset (109) into replay (110), the user may learn information pertaining to or indicative of the outcome or content of the event which spoils the replay (110).

In the depicted embodiment of FIG. 1, one or more messages (107) inhibited from delivery during original broadcast (100) are delayed for delivery (111) at a corresponding point (113) during replay (110). In the depicted embodiment, this is done by calculating a delivery time (113) during the replay (110) and delivering (111) the content (107) or causing the content (107) to be delivered (111) at that corresponding delivery time (113). In the depicted embodiment, the delivery time (113) for each message (107) is calculated by adding the time offset (109) of each message to the start time (114) of replay (110). The delayed messages (111) are then delivered (111) at the corresponding delivery time (113).

By way of example and not limitation, in FIG. 1 message (107A) is published during original broadcast (100) at 11:09 am (108A), nine minutes after start time (101) of 11:00 am. This results in a time offset (109A) of nine minutes. For sake of simplicity in this example, seconds are disregarded, though the number of seconds is generally important and is generally included in the calculations. A user who would ordinarily receive message (107A) at about 11:09 am would instead not receive message (107A) at that time, but rather the message is inhibited from delivery at that time. When the user replays (110) the broadcast later beginning at replay start time (114) of 9:37 pm, the time offset (109A) of nine minutes is added to start time (114) of 9:37 to calculate delivery time (113A) of 9:46 pm. Thus, just as the user would have received message (107A) about 9 minutes into original broadcast (100) had the user been watching original broadcast (110) live, the user will receive a delayed message (111A) about 9 minutes into replay (110).

In an embodiment, messages (107) the user would have received during the original broadcast (100) are delivered as delayed messages (111) at corresponding points during the replay (110). However, in alternative embodiments, the user is not necessarily confined only to receiving messages the user would have received live, but may also receive messages about the content which the user would not have received during the live broadcast. For example, if the user was not following a particular actor on Twitter during the original broadcast of a new episode, the user might not have seen the social networking content from the actor even if the user was watching the original broadcast (100) live. Using the systems and methods described herein, the user could replay the broadcast and also view the social networking content provided by the actor synchronized to the replay (110), as described elsewhere herein.

While it is generally contemplated that messages will be inhibited or prevented from real-time delivery when such messages are initially published during the original broadcast, and then the inhibited messages will be delivered at a corresponding point into a replayed broadcast, it is also specifically contemplated that a message may be inhibited from initial delivery without a later delivery. This is particularly useful where, for example, a user simply wishes to “block out” spoilers and does not care whether the user also views the social networking content replay during the broadcast replay.

A feature of the systems and methods is that the user may optionally allow delivery of messages which are determined not to pertain to an event. This permits other messages to reach the user while reducing the risk that the user inadvertently learns of the outcome of the event. By way of example and not limitation, Facebook updates which are determined not to contain spoilers may be delivered, while other updates may be blocked. In an embodiment, the user may be provided an indication of a blocked message, and some information about the blocked message, such as the author and publication time. The user may have the option of allowing delivery anyway. In an alternative embodiment, authors sending messages to a user may provide an indication that the message sent is not about an event, allowing such messages to be delivered normally in real-time.

In an embodiment a user provides an indication of an event the user will watch on replay. This indication may be provided through a GUI as described herein or may be implicit, in that the user may select a given event to record, such as through a DVR, implicitly indicating that the user will watch the recording later.

In an embodiment a user provides an indication of social networking platforms or contacts subject to synchronized delivery. This indication may be provided through a GUI as described herein or may be implicit, in that the user may indicate through software associated with a platform that the user will record a given event, implicitly indicating that the user will watch the recording later and that messages on the platform should be filtered.

A component of the systems and methods is identifying social networking content pertaining to the subject event. This may be done through any means now known or in the future developed in the art. In an embodiment, an indication of social networking users whose content should be filtered is provided. In such a “list” approach, if a social networking message is from a user on the list, the message is subject to delayed synchronized delivery as described herein regardless of content. This is particularly useful where, for example, a given social networking contact is concerned primarily with the subject event. By way of example and not limitation, a fan of a particular sports team may wish to delay delivery of all Twitter communications from a beat writer covering a game which the team has played.

Also by way of example and not limitation, a user following actors in a television program which has just aired a new episode may wish to delay delivery of all messages from the actors. In an embodiment using the “list” approach, multiple lists may be used and filtering may be done on a list basis. For example, a fan of a particular sports team may follow athletes, coaches, and sports writers covering that team, and may create a Twitter list of such users. In an embodiment, the user may allow normal delivery of messages except for messages from social networking contacts on that list. In an alternative embodiment, the “list” feature is provided independently of the social networking platform. In such an embodiment, the feature may operate on a cross-platform basis.

Messages may also be filtered based on message content, such as the message text itself, metadata, or social networking factors such as who else follows or is connected to the author, who republishes the message, who else receives the message, when the message is sent, and other factors. In certain embodiments users may flag messages to indicate whether a message was handled correctly. This feedback may be used to improve the algorithm, for example through machine learning.

Another feature of the systems and methods is identifying or recognizing periods of time when an even is taking place and thus when time-sensitive messages pertaining to the event should be processed as described herein. This is because users may wish to receive social networking content from all users, except during original broadcasts of relevant events. This may be done through a third party database containing indications of relevant time periods for specific events, or for categories of interests or activities. The database may be queried to request relevant time frames.

The software implementation may comprise a mod, plug-in, or add-on to an existing social networking platform, a social network aggregation platform, a middleware layer, a standalone application, a third party client/server system, a firewall or content filter or any other mechanism now known or in the future developed in the art for implementing the described functionality, and/or a combination of two or more of these. Access to content and messages may be accomplished through use of APIs associated with the various social networking platforms.

In an embodiment a graphical user interface (“GUI”) is used for providing configuration and user input options. The precise content of the GUI will vary from embodiment to embodiment depending on features implemented, system architecture, aesthetic choice, artistic discretion, and so forth. Functionally, it is desirable to provide a simple interface which requires minimal input. For example, in an embodiment, the user may be presented with a list of upcoming original broadcasts, and the user may indicate which original broadcasts the user wishes to record and watch later. The recordation of either or both the original broadcast and pertinent social networking content will then be automatically configured and performed, based on pre-set configuration data provided by the user, configuration data provided or controlled by a third party service provider, and/or a combination of the two. For example, the user may have configured the system to associate a specific list of contacts as relevant to a particular sports team. When the user indicates that the user will watch a given game involving that sports team on delay, relevant content from contacts on that list may be subject to delayed and synchronized message delivery as described herein.

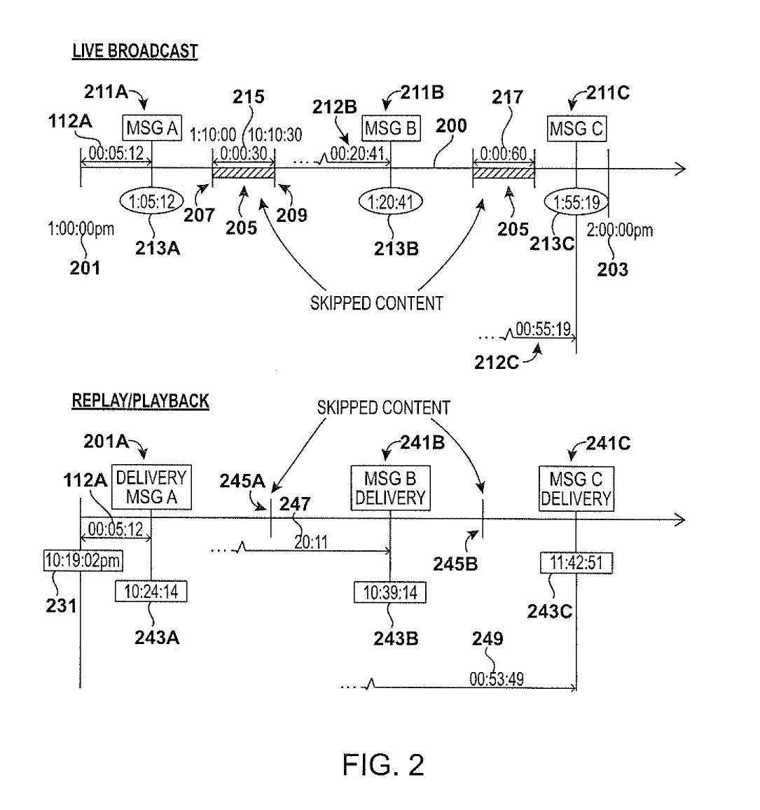

It is common in content replay to skip certain content, such as commercials. FIG. 2 depicts an embodiment supporting content skipping. In such an embodiment, the start (207) time, stop time (209), and/or duration (205) of a commercial (215) during a broadcast is used to adjust the delivery time (243) of messages (211B, 211C) sent after the commercial during the original broadcast (100) if the user skips the commercial (215). For example, in the depicted embodiment, commercial (215) airs at 1:10:00 pm (207) and ends at 10:10:30 (209), for a duration of 30 seconds (205). Message (211B) was sent at 1:20:41 pm during the original broadcast. If the user on replay skips commercial (215), then the social networking replay for content during and after commercial (215) will become de-synchronized by 30 seconds, causing the user to receive replay content 30 seconds sooner than pertinent social networking messages about the replay content. To solve this, when the user skips commercial (215), the duration (205) of the commercial is subtracted from the calculated delivery time (243B) of the delayed message (241B), to account for the skipped portion.

Similarly, if a second commercial (217) is skipped, the duration (205) of the second commercial must also be subtracted from the delivery time (243C) of delayed messages (241C) delivered after the second commercial (217). Thus, whereas message (211B) would ordinarily have a time offset into the original broadcast of 20 minutes and 41 seconds (213B), due to the 30 second (205) skipped commercial (215), 30 seconds is subtracted from time index (213B) to change it to 20 minutes and 11 seconds (247). This offset is then used to calculate the proper synchronized delivery time (243B) during the replay.

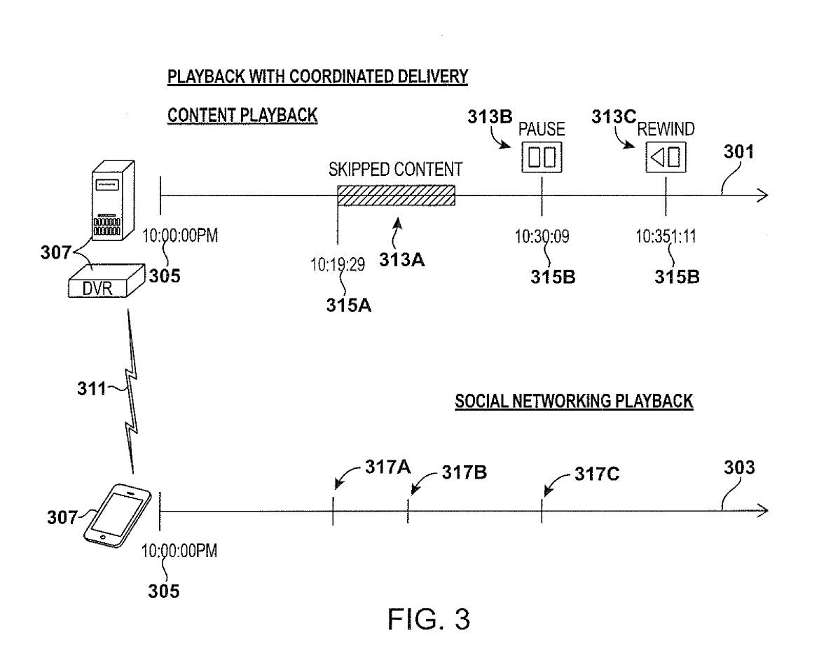

This technique may be further refined in an embodiment to accommodate arbitrary user-initiated changes in playback, such as rewinding, pausing, and fast-forwarding. In the depicted embodiment of FIG. 3, for example, the device (307) playing back the original broadcast (e.g., a DVR) is in communication (311) with a user device (309) (e.g., a mobile phone, tablet PC, desktop PC, or other computer) replaying social networking content, and provides indications of user changes in playback flow. The delivery time of social networking content on device (309) is then altered to correspond to such changes. For example, a user is watching a replay of a football game which began at 10:00:00 am, and at about 10:19:29 am, the broadcast is interrupted for local a weather emergency. Because the user is watching the broadcast on replay, the weather event is in the past and the user doesn't care about the notice and wishes to skip the weather notice portion (313A) of the replayed broadcast. However, the duration of the weather emergency update is not known, and so the user simply fast-forwards until the weather content (313A) appears to have concluded and the game broadcast returns. The user begins to fast-forward at about 19 minutes 29 seconds into the broadcast, and an indication that the user has commenced a fast-forward action is sent (311) from the DVR device (307) to device (309). Device (309) may pause or halt social networking replay upon receiving such notice.

When the user stops fast-forwarding, the DVR (307) sends (311) an indication to device (309) that the user has stopped fast-forwarding, and an indication of the time offset into the broadcast the user is now viewing. Device (309) may then “fast-forward” its own playback of social networking content, such as through a mass-delivery of the social networking content which was originally published during the skipped content (313A), or may simply not deliver any such content, and instead commence with delivery of messages synchronized to the corresponding time offset into the replayed broadcast at which the user resumed normal viewing. This effectively allows social networking playback (303) to “fast-forward” in synchronization with a “fast forward” in the broadcast reply (301).

This technique may also be used to facilitate other playback control features. For example, if a user pauses the replay (313B) at a certain point (315B) into the broadcast, an indication of same is sent (311) to device (309) so that it can pause the playback of social networking content as well (317B). When the user un-pauses, an indication of the unpause action is again sent (311) from DVR (307) to device (309) to resume social networking playback (303) and keep the two playbacks (301, 303) in synchronization.

This feature may also be used to facilitate rewinding, as depicted in FIG. 3. Social networking playback may be paused while the user rewinds and, when the user resumes playback at a previous point, an indication of the new time offset the user is viewing is sent (311) to device (309) to play back social networking content at the corresponding point in time. In an alternative embodiment, when a user rewinds, the “leave off” point at which the user rewound is noted, and social networking playback is simply paused until the user's viewing time offset into the broadcast catches back up to the “leave off” point. This way, users may rewind the broadcast without also rewinding social media play back, and pick up social media content where they left off in viewing the broadcast.

Although FIG. 3 is described with reference to a replayed broadcast, the systems and methods apply equally to live original broadcasts. It is not uncommon for viewers of a live original broadcast to pause or rewind, and the systems and methods may be used in connection with live broadcasts to coordinate and synchronize the pausing and/or rewinding of social media playback. By way of example and not limitation, a user watching a live sporting event may wish to rewind a great play to view it again, and then may be a few seconds “behind” the live broadcast. The user will often “catch up” to the live broadcast later, such as when the user reaches the next commercial break and “fast forwards” through some of it. Using the techniques described here, an indication of the user control of the DVR is sent (311) to the social networking playback device (309) to coordinate pausing, rewinding, and fast-forwarding of social networking content in synchronization with the user's viewing of the nearly-live broadcast.

It should also be noted that although two difference devices (307 and 309) are depicted, it is expressly contemplated that one device may be used for both playback of the original broadcast and social networking content. In such an embodiment, communication (311) may be local rather than over a network or other connection, or may not be necessary because both sets of replay functionality are incorporated into one or more software modules on the same device.

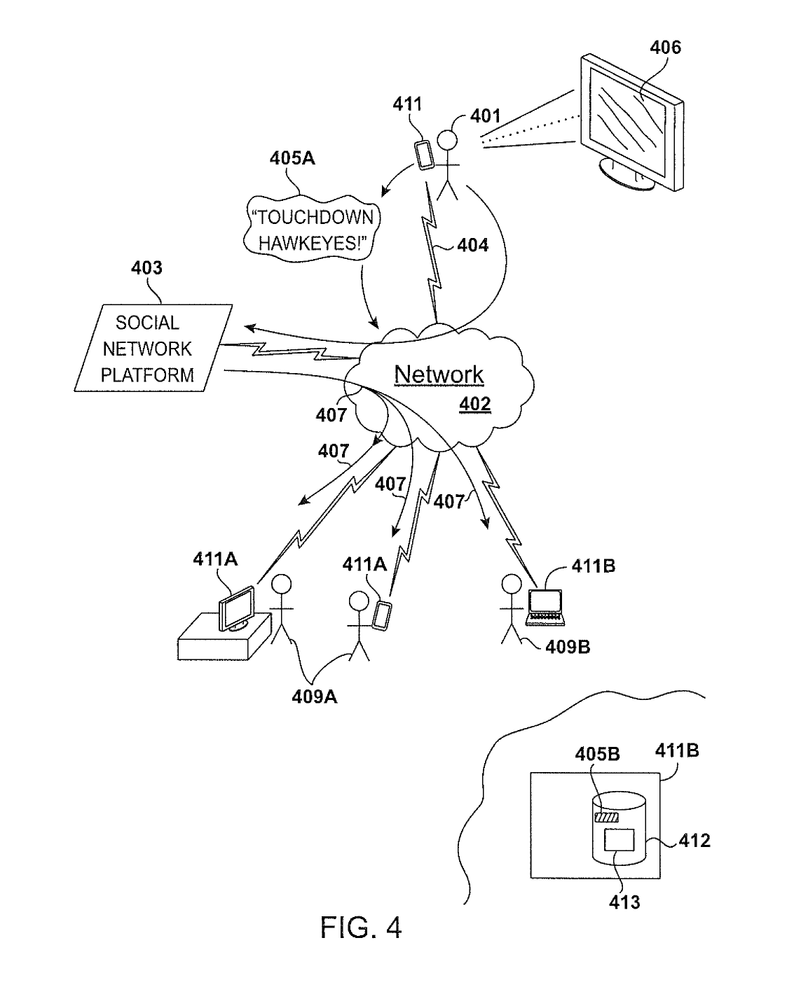

A number of system arrangements are possible. By way of example and not limitation, in the depicted embodiment of FIG. 4, a posting user (401) of a social networking platform (403) uses a device (411) posts (404) a message (405A) pertaining to a broadcast event (406) to the platform (403), which message (405) is then distributed (407) to receiving users (409) on receiving user devices (411). For receiving users (409A) watching the event (406) live during the original broadcast, the message (405A) is delivered in real-time. However, for a receiving user (409B) who will watch the event (406) after the original broadcast, a software agent (413) on the device (411A) memory systems (412) identifies that the content (405A) pertains to the event (406) and inhibits the message (405A) from being delivered to the receiving user (409B) in real-time. Instead, software agent (413) stores a copy (405B) of the message (405A) on the device (411A) memory systems (412). Later, when receiving user (409B) watches a replay of the broadcast (406), the software agent (413) allows or causes the stored message (405B) to be delivered to the user (409B) by reading the stored message (405B) from the device (411B) memory (412) and delivering it to the user (409B). This arrangement has the advantage that if the device (411) is offline or does not have network capability, the software agent (413) will still work properly and the user (409B) can replay the stored social networking content (405B). Communication is generally facilitated by a network (402) such as the Internet. This arrangement also does not require additional infrastructure in the form of a third party caching or storage service.

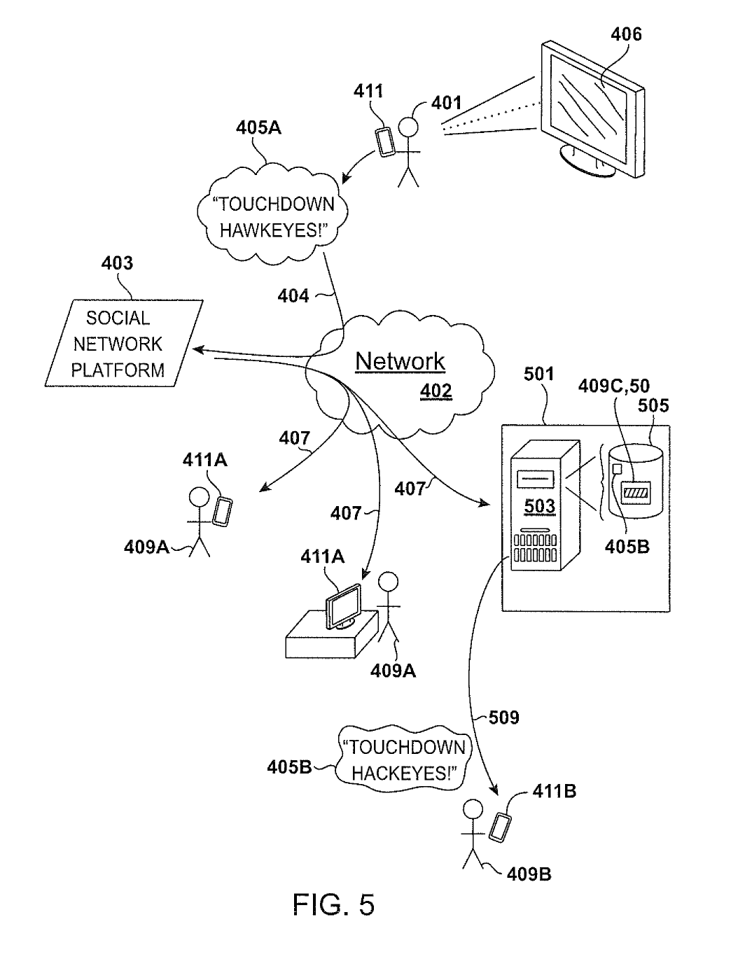

In an alternative embodiment, such as the embodiment depicted in FIG. 5, a third party service provider system (501) is used to store pertinent messages (405A) for delayed delivery in synchronization with a replay. In the depicted embodiment of FIG. 5, a posting user (401) of a social networking platform (403) uses a device (411) to post (404) a message (405A) pertaining to a broadcast event (406) to the platform (403), which message (405) is then distributed (407) to receiving users (409) on receiving user devices (411A). For receiving users (409A) watching the event (406) live during the original broadcast, the message (405A) is delivered in real-time. One such receiving user (409C) is a software agent (507) in the memory systems (505) of a computer server (503) at a third party service provider (501). The software agent (507) identifies that the content (405A) pertains to the event (406) and inhibits the message (405A) from being delivered to the receiving user (409B) in real-time. Instead, a copy (405B) of the message (405A) is stored in memory (505) at the third party service provider (501). Later, when receiving user (409B) watches a replay of the broadcast (406), the software agent (507) allows or causes the stored message (405B) to be delivered (509) to the user (409B) by reading the stored message (405B) from memory (505) and delivering (509) it to the user (409B). This arrangement has the advantage that the social networking content can be replayed to any device and is not limited to the device which initially received the content. This also has the advantage that if the device is off-line or unavailable, the content is not lost.

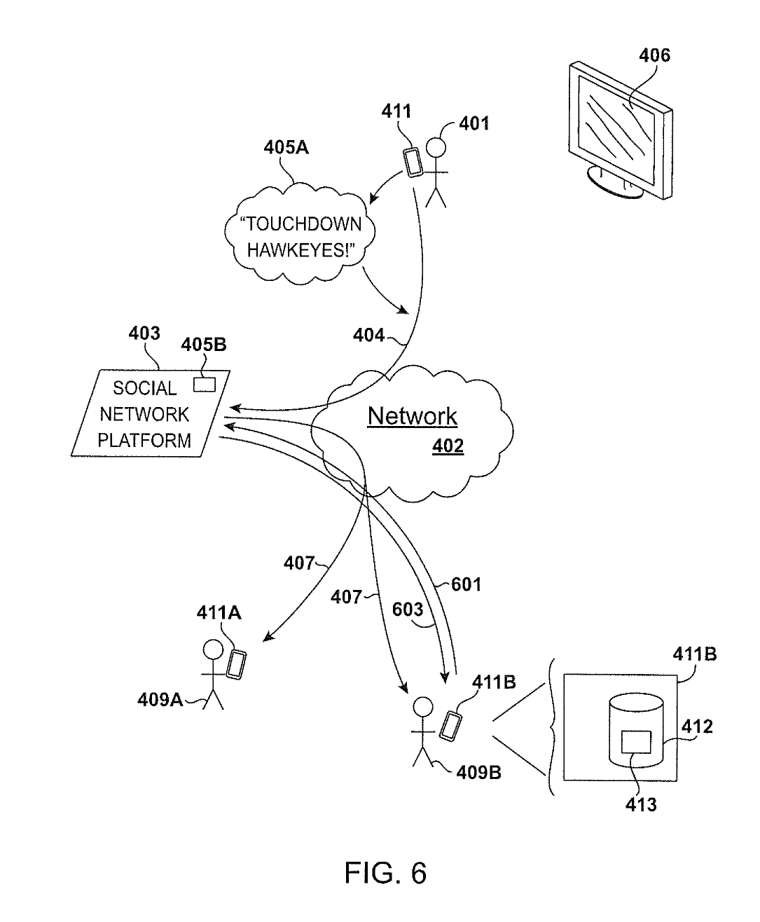

In a still further embodiment, such as the embodiment depicted in FIG. 6, the social networking platform (403) itself is used to store messages. It is common and generally necessary in social networking platforms (403) that messages be stored in some memory systems controlled or hosted by the platform for later retrieve by users, who may not necessarily be using the platform when each message is first sent. In the depicted embodiment of FIG. 6, a posting user (401) of a social networking platform (403) uses a device (411) to post (404) a message (405A) pertaining to a broadcast event (406) to the platform (403), which message (405) is then distributed (407) to receiving users (409) on receiving user devices (411) in real time. For receiving users (409A) watching the event (406) live during the original broadcast, the message (405A) is delivered in real-time.

However, for a receiving user (409B) who will watch the event (406) after the original broadcast, the software agent (413) on the device (411A) memory systems (412) identifies that the content (405A) pertains to the event (406) and inhibits the message (405A) from being delivered to the receiving user (409B) in real-time. In such embodiment, a local copy need not be stored for replay. Rather, the social networking platform (403) stores a copy (405B) on the memory systems of computer servers associated with the social networking platform (403). The social networking platform (403) stores messages (405B) as a matter of course, without regard to whether a user will view the message in real-time or at a later point. Later, when receiving user (409B) watches a replay of the broadcast (406), the software agent (413) queries (601) the social networking platform (403) and requests a copy of relevant messages (405B). Social networking platform (403) returns copies (603) of the responsive messages (405B), which are then delivered to user (409B) in synchronization with the replayed broadcast.

It is important to note that the division of labor between software agent (413) and social networking platform (403) may vary from embodiment to embodiment, based on engineering and design principles, network traffic, and query capability, among other factors. By way of example and not limitation, where social networking platform (403) provides a API to request messages sent during a specific time period, software agent (413) may request only messages sent between the start and end time of the broadcast (406). However, where the platform (403) does not provide such an API, software agent (413) may request all messages from the last 24 hours, or such other request as is supported by the API, so that the software agent (413) can acquire a set of messages that include messages sent during the broadcast (406), and software agent (413) filters out messages outside the relevant time frame.

This system has the advantage that message storage need not be duplicated. This arrangement also allows the user to query messages that the user would not have received lived. For example, in the embodiment of FIG. 6, the user could replay a broadcast and also replay social networking messages sent by contacts whom the user did not follow or have a social networking connection with during the broadcast. This system might be used even where the user did watch the original broadcast live. For example, the user might watch the original broadcast without simultaneously watching social networking traffic, and then later replay the broadcast with synchronized social networking pertaining to the broadcast.

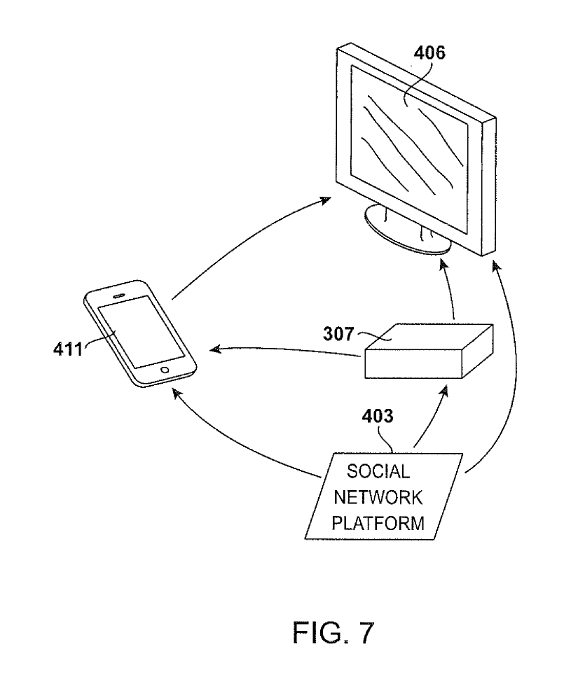

In the depicted embodiment of FIG. 7, the social networking platform (403) may communicate directly with a DVR (307) device, such as through programming on the device (307), or through an API to the device's functions. Additionally or alternatively, the platform (403) may communicate directly with the television (406), such as through programming offered on or via the television (403), or through an API to the television's (406) functionality. By way of example and not limitation, modern “smart TVs” generally are shipped with pre-loaded applications, or have downloadable applications, which run on the television (406) and access services over a network. It is contemplated that the television (406) may itself also serve as the DVR (307) in certain contexts.

Also in the depicted embodiment of FIG. 7, the DVR (307) may communicate directly or indirectly with the social networking playback device (411) to coordinate playback between the two devices. That is, when the user pauses playback on the DVR (307), the pause command is transmitted to the user device (411) so that it too can pause social networking content playback. Likewise, as described elsewhere herein, other playback control features and commands may be transmitted or exchanged, such as reward, slow motion, freeze frame, fast-forward, and so forth. These commands may be exchanged using an API into the DVR's functions, or using programming integrated into or available via the DVR. Communication may be wired or wireless, and may use, for example, BlueTooth or other wireless protocols, or Internet Protocol communication. By way of example and not limitation, where the device (411) is communicably attached to a local area network to which the DVR (307) is also communicably attached, the devices may communicate over the LAN. In a still further embodiment, the device (411) is programmed for controlling the DVR (307), such as through a “remote control” application. This application may be used to control both content playback on the DVR (307), but social networking playback on the device (411).

In an embodiment, one or more list of relevant social networking contacts or messages pertaining to a broadcast are prepackaged. Users can subscribe to such lists when replaying broadcasts to get key relevant social networking related to the broadcast. For example, for a final episode of a popular show, the directors, producers, actors, crew, critics, and other persons interested in the show may have interesting commentary about the show's content. A list of such people may be prepackaged such that a user replaying the broadcast can “subscribe” to the list and receive the social networking content from the people on the list. This enables users to quickly select content to replay and automatically receive highly relevant social networking content pertaining to the broadcast without having to establish social networking contacts with each individual. This prevents social networking contacts lists from becoming cluttered, and allows users to quickly find relevant social networking content without extensive research or effort, effectively creating an ad hoc “commentary track” over social media for the show. This feature may also be offered with live broadcasting, so that users consuming the original broadcast live can also quickly find and view relevant social networking content. Such lists may be offered at varying levels of detail, including but not necessarily limited to: key cast only; all cast; production/directorial staff; key cast and crew; all cast & crew; and so forth. Similar lists may be offered for other types of events, such as sporting events, concerns, and breaking news stories.

It will be appreciated by one of ordinary skill in the art that other techniques for synchronizing playback are described and included within the scope and spirit of this disclosure. By way of example and not limitation, an alternative to storing a relative time index is to use an absolute time index, such as according to a particular time tracking schema (e.g., GMT), and as programming is played back via the DVR, mathematical operations are used to determine when, during said playback, the message should be delivered. By way of example and not limitation, where the event began at 13:05 GMT and a particular message was published at 13:09 GMT, the time value of 13:09 GMT may be stored for the event (rather than an offset of 00:004). The time at which the message should be delivered during playback can then be calculated ad hoc by first calculating the time difference between the commencement time of the event and the commencement time of the playback. Thus, if playback begins at 19:12 GMT (i.e., 6:07 after the event commencement time), then the calculated difference of 6:07 may be added to the time index of 13:09 to determine that the message, originally published at 13:09, is delivered at 19:16.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A method for synchronized playback of social networking content comprising:
providing a social networking platform;
providing a digital video recorder communicably attached to a network;
providing a social networking playback device communicably attached to said network;
indicating to said digital video recorder a live event desired to be recorded;
sending over said network an indication of said desired live event and an indication of a user of said social networking playback device;
a server receiving said indication of said desired live event and said indication of said user;
said desired live event commencing at an event start time;
during said desired live event, said server monitoring said social networking platform for one or more social networking messages for said received indication of said user related to said received indication of said desired live event and, for each social networking message in said one or more social networking messages, calculating and storing a time index indicating a time during said desired live event when said each message was published on said social networking platform relative to said event start time;
during said desired live event, said digital video recorder recording said desired live event;
using said digital video recorder, playing back said recording of said desired live event at a playback starting time;
for each social networking message in said one or more social networking messages, displaying said each social networking message on said social networking playback device at a point in time corresponding to said calculated time index for said each message relative to said playback starting time.

2. The method of claim 1, further comprising:
during said desired live event, preventing at least one of said one or more social networking messages from being displayed on said social networking playback device.

3. The method of claim 2, further comprising:
displaying on said social networking playback device, in place of said prevented at least one message, an indication that said prevented message was prevented from being displayed on said social networking playback device.

4. The method of claim 3, wherein said displayed indication that said prevented message was prevented from being displayed on said social networking playback device further comprises a user-operable interface component which, if operated by the user, causes said prevented message to be displayed on said social networking playback device.

5. The method of claim 1, wherein said social networking playback device is a mobile phone, tablet computer, or wearable computer.

6. The method of claim 1, wherein said network is the Internet.

7. The method of claim 1, wherein said live event is a sport.

8. The method of claim 1 further comprising:
in response to a user command pausing playback on said digital video recorder, said digital video recorder causing said user device to pause playback of said one or more social networking messages.
